(19) United States
(12) Patent Application Publication
(10) Pub. No.: US 2001/0034607 A1
(43) Pub. Date: Oct. 25, 2001

(54) System for providing automated real estate services

(76) Inventors: Walter F. Perschbacher III, Grand Rapids, MI (US); John J. Smith, Holland, MI (US); Michael J. May, Grand Rapids, MI (US); Richard D. Ullrey, Grand Rapids, MI (US); Thomas P. Paarlberg, Alto, MI (US); Graham C. Duryee, Holland, MI (US); Marc Dion, Caledonia, MI (US); Richard A. Morton, Grand Rapids, MI (US)

Correspondence Address: PRICE HENEVELD COOPER DEWITT & LITTON, 695 KENMOOR, S.E., P O BOX 2567, GRAND RAPIDS, MI, 49501, US

(21) Appl. No.: 09/775,917

(22) Filed: Feb. 2, 2001

Related U.S. Application Data
(60) Provisional application No. 60/180,321, filed on Feb. 4, 2000.

(51) Int. Cl. G06F 17/60

(52) U.S. Cl. 705/1

(57) ABSTRACT

A real estate service system for providing real estate services in a retail shopping mall includes a server for storing and providing automated access to real estate service information and a real estate kiosk that includes a computer system that is coupled to the server. The real estate kiosk is located in a retail shopping mall and provides automated real estate service information to a potential buyer based on the potential buyer's indicated preference. The computer system includes a processing unit, a storage unit, an output unit and an input unit. The storage unit is coupled to the processing unit and stores real estate service information. The output unit is coupled to the processing unit and provides real estate service information that corresponds to the potential buyer's indicated preference. The input unit is also coupled to the processing unit and receives the potential buyer's indicated preference.

This application claims priority based on U.S. Provisional Patent Application Ser. No. 60/180,321 entitled, “SYSTEM FOR PROVIDING AUTOMATED REAL ESTATE SERVICES,” by Walter F. Perschbacher III et al., filed Feb. 4, 2000, the disclosure of which is hereby incorporated by reference.

### BACKGROUND OF THE INVENTION

The present invention is directed to a system for providing real estate services, and more specifically to a system for providing automated real estate services.

Traditionally, residential real estate services have been provided by real estate agents that are located in a stand-alone real estate office building. The agent has normally communicated with a potential buyer via the telephone or in-person. In a typical situation, a potential buyer contacts the agent after having written down the agent's telephone number, as listed on a real estate sign placed near a property that is for sale. After speaking with the agent, the potential buyer may schedule a time for walking through the property and may provide the agent with certain criteria that the potential buyer desires in a property.

After reviewing the potential buyer's criteria, the agent typically accesses an exclusive or multiple listing service (MLS) database to retrieve information on properties that may be of interest to the potential buyer. That information is normally provided to the potential buyer in the form of an information sheet. The information sheet may provide a picture of a property (e.g., a home) and characteristics of the property and its surrounding area. For example, a residential information sheet typically includes: an asking price of the home; square footage of the home; the number of bedrooms; the number of bathrooms; how many cars the garage will hold; whether the home has central air-conditioning; the school district that the home is located in and various other information that may be of interest to a potential buyer.

If the potential buyer is interested in purchasing a particular property, after receiving the information sheet from the agent, the potential buyer typically schedules a time in which to walk through the property. These viewings are typically performed after work hours, of the potential buyer, or on a weekend. Typically, the potential buyer arranges to meet the agent at the agent's office at which point the agent, who has scheduled a walk through with the sellers of the properties of interest, drives the potential buyer to the properties in which the potential buyer has expressed an interest. This process may continue for several weeks and/or months and consume considerable amounts of time for both the potential buyer and the agent.

In an effort to reach more potential buyers, many agents advertise in newspapers and on television. In addition, some agents have placed information on selected properties in retail shopping malls. This information has typically been presented in the form of an information sheet, including a picture of the property, placed with information sheets on numerous other properties on a bulletin-board type system. Some of these bulletin-board type systems have been located within a kiosk in a common area of a retail shopping mall. Other agents have embraced technology and presented information on available properties, via the Internet. This information has, in some cases, included virtual tours of selected properties. However, these virtual home tours have required the downloading of computer files, (e.g., JPEG files) that contain information on a property of interest, to the potential buyer's computer system, which can be a lengthy process.

As such, an automated real estate service system that efficiently provides real estate service information and allows a potential buyer the ability to view a property of interest on their own time schedule, without actually walking through the property, is desirable.

### SUMMARY OF THE INVENTION

An embodiment of the present invention is directed to a real estate service system for providing real estate services in a retail shopping mall. The system includes a server for storing and providing automated access to real estate service information and a real estate kiosk that includes a computer system that is coupled to the server. The real estate kiosk is located in a retail shopping mall and provides automated real estate service information to a potential buyer based on the potential buyer's indicated preference. The server may be located in the mall or in a remote location. The computer system includes a processing unit, a storage unit, an output unit and an input unit. The storage unit is coupled to the processing unit and stores real estate service information. The output unit is coupled to the processing unit and provides real estate service information that corresponds to the potential buyer's indicated preference. The input unit is also coupled to the processing unit and receives the potential buyer's indicated preference.

These and other features, advantages and objects of the present invention will be further understood and appreciated by those skilled in the art by reference to the following specification, claims, and appended drawings.

### BRIEF DESCRIPTION OF THE DRAWINGS

In the drawings:

FIG. 1 is a block diagram of a real estate service system, according to an embodiment of the present invention;

FIG. 2 is a block diagram of a computer system, implemented according to an embodiment of the present invention; and

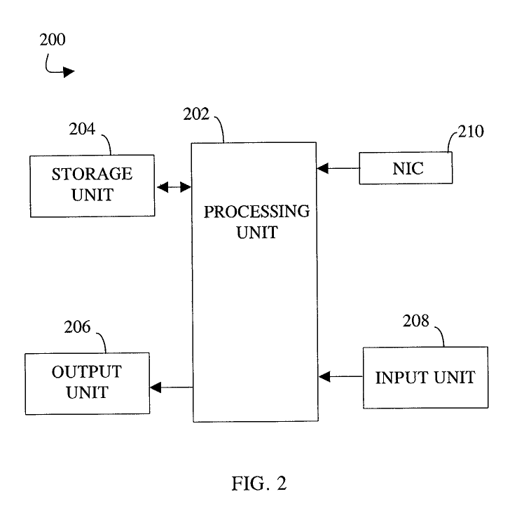

FIG. 3 is a partial floor plan of a real estate storefront, according to an embodiment of the present invention.

### DETAILED DESCRIPTION OF THE PREFERRED EMBODIMENTS

The present invention is directed to a system for providing automated real estate services to a potential buyer. In one embodiment, the system includes a real estate kiosk, an insurance kiosk and a mortgage kiosk. The real estate kiosk includes a real estate computer system that is coupled to a server. The real estate computer system automatically provides real property information to a potential buyer based on the potential buyer's indicated preferences. The insurance kiosk includes an insurance computer system that is coupled to the server. The insurance computer system automatically provides insurance information to a potential buyer based on the potential buyer's indicated preferences. The mortgage kiosk includes a mortgage computer system that is coupled to the server. The mortgage computer system automatically provides mortgage information to the potential buyer based on the potential buyer's indicated preferences. While each of the real estate, insurance and mortgage kiosks, as described above, include a separate computer system; one of ordinary skill in the art will appreciate that a single computer system implemented in a single kiosk can provide real property, insurance and mortgage information.

In one embodiment, the real estate, insurance and mortgage kiosks are located in a retail shopping mall. This allows a potential buyer to browse real estate service information in a single area, unimpeded by an agent. Thus, a potential buyer may peruse real property information while on a shopping trip for other merchandise. Additionally, the potential buyer can receive insurance information that corresponds to a property of interest. Utilizing the mortgage kiosk, the potential buyer can determine rates and/or the monthly mortgage payment for a selected property, among others, and thus determine, in advance, whether he/she can afford the selected property. In another embodiment, the real estate kiosk is located in a common area of the retail shopping mall. Preferably, the real estate, insurance and mortgage kiosks are located in the browsing area of a real estate storefront located within a retail shopping mall.

In a preferred embodiment, the real estate store front includes: a browsing area where the real property, insurance and mortgage kiosks are located; an Internet access area that is separate from the browsing area; and a virtual home tour area that is separate from the browsing and the Internet access areas. The virtual home tour area includes a virtual home tour unit that provides interactive views of at least one real property that is for sale. A virtual home tour can be conducted after the potential buyer selects a number of properties that are of interest and contacts an agent, giving the agent the addresses and/or corresponding MLS numbers of the property. The agent then sets up an appropriate time for the buyer to view videos of the property. The videos of the properties of interest are downloaded to a virtual home tour computer system such that the buyer can view the properties, as desired. Preferably, the videos (e.g., JPEG files) include interior, exterior and ground views of at least one property for sale.

In this manner, a potential buyer can review multiple properties in a fraction of the time that would be required to review those same properties using traditional techniques (i.e., having an agent drive the potential buyer to each property and walking through the properties). As such, both the potential buyer's time and the agent's time are conserved. For example, a potential buyer could choose to come to the storefront and view multiple properties after work. Traditionally, most homes are not routinely available for viewing during all times. As such, a system according to the present invention allows potential buyers to view properties at virtually any time or any day of the week (limited only by the agent's availability to provide access to the virtual home tour area).

Preferably, the computer system of each kiosk and/or area includes: a processing unit, a storage unit, an output unit and an input unit. The storage unit is coupled to the processing unit and includes an application appropriate amount of random access memory (RAM) and read-only memory (ROM), as well as, a hard disk unit for storing various files. The output unit is also coupled to the processor and may include voice processing circuitry coupled to a speaker (that when located within a real estate kiosk provides audio about a specific property/listing), a liquid crystal display (LCD) and/or a conventional cathode ray tube (CRT). The input unit is also coupled to the processing unit and receives input from a potential buyer. The input unit can be a keyboard, a mouse or may be combined with an output unit, in the form of a touch screen. In another embodiment, each kiosk has an associated smart phone. As is well known to one of ordinary skill in the art, a smart phone is a dedicated phone that, when the handset is picked-up, dials a specific number and puts the user of the phone in contact with an individual and/or a computer system that provides another source of information,

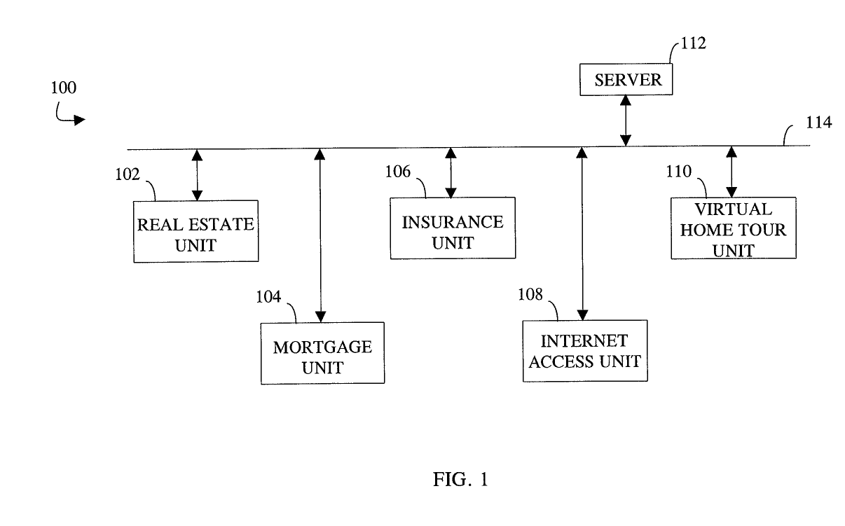

FIG. 1 is block diagram of a real estate service system 100, according to an embodiment of the present invention. The system includes a server 112, which communicates with the various units 102, 104, 106 and 110 via, for example, an intranet 114 such as a local area network (LAN) 114 (e.g., an Ethernet). In this configuration, the server 112 is a local server. Alternatively, intranet 114 can be a wide area network (WAN) or any other type of network that is capable of sustaining a required traffic load. In this configuration, the server 112 is a remote server. As briefly discussed above, coupled to intranet 114 is a real estate unit 102, a mortgage unit 104, an insurance unit 106, an Internet access unit 108 and a virtual home tour unit 110. In a preferred embodiment, the real estate service information on units 102, 104 and 106 is automatically updated daily, via server 112. Server 112 receives updated information from various sources (e.g., MLS databases, web sites, etc.), via, for example, an Internet connection. As previously mentioned, real estate unit 102 provides real estate information on various properties that are for sale. A potential buyer can access information on various properties, in a specific geographic area, by entering that location and entering a property value or a range of property values (among others) in which the potential buyer wishes to be presented with.

Mortgage unit 104 allows a potential buyer to determine how expensive of a property the potential buyer can afford. This is accomplished by entering various information about the potential buyer, such as yearly income, current debt load per month, etc. Mortgage unit 104 can also be utilized to apply for a loan. That is, a potential buyer can fill out an application and submit it electronically through mortgage unit 104. When utilized in this manner, a screening device 344 (e.g., a partition wall) can be utilized to prevent an individual that is passing by from viewing the potential buyer's personal information. Insurance unit 106 allows a potential buyer to determine the cost of insurance of a specific property in a desired location and apply for an insurance policy. Preferably, both mortgage unit 104 and insurance unit 106 include a smart phone that directly dials an appropriate number (i.e., a lender or an insurance agent, respectively) when the potential buyers removes the handset from its holder. The smart phone, as above, allows the potential buyer to receive appropriate information directly from another source of information (e.g., the lender or the insurance agent).

As previously mentioned, a potential buyer can view a number of videos (e.g. JPEG files) on properties of interest, utilizing virtual home tour unit 108. The virtual home unit 108 is utilized after a potential buyer selects a number of properties (e.g., using a real estate unit 102) in which they would like to interactively tour. When the potential buyer determines which properties they would like to view, they contact an agent to set up a time for viewing the selected videos. The agent contacts a technician who downloads (e.g., from server 112) the appropriate video files to virtual home tour unit 108 (i.e. the computer system of virtual home tour unit 108) and readies virtual home tour unit 108 for viewing of the video files at the appropriate time.

As stated above, this allows a potential buyer to view the interior, as well as, the exterior of a property and determine whether further investigation is warranted (i.e., a walk through). Utilizing the virtual home tour unit 110, the potential buyer can zoom and pan, as well as, rotate through the property of interest. This is facilitated by real estate personnel who have videoed both the interior and exterior of the property.

The Internet access unit 108 enables a potential buyer to browse the Internet, while at the real estate storefront to determine if other properties are available, in a given geographical location, that have not already been located. This enables the potential buyer to determine if other properties, not available through the agent, are available. Thus, a potential buyer can satisfy themselves by knowing that the agent is giving them a full range of the available properties, in a given geographic area and/or price range.

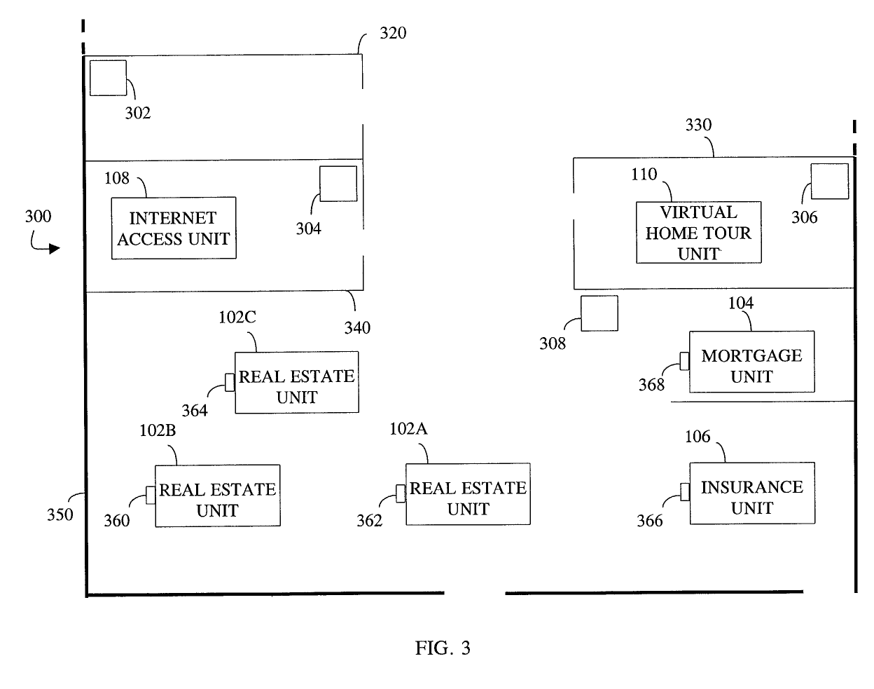

FIG. 3 is a partial floor plan view 300 of a real estate storefront, according to an embodiment of the present invention. As depicted in FIG. 3, floor plan 300 includes a browsing area 350, an Internet access area 340, a virtual home tour area 330 and a secured children area 320. Browsing area 350 may include a plurality of real estate units 102A, 102B and 102C, a mortgage unit 104 and an insurance unit 106. A screening device 344 may be provided to shield personal information of a potential buyer, utilizing mortgage unit 104, from the view of other individuals. As previously discussed, a secured children area 320 is provided such that a potential buyer can monitor the activity of secured children area 320 from Internet access, browsing or virtual home tour areas 340, 350 and 330, respectively. This is facilitated by a video surveillance camera 302, which is located in secure children area 320. Video surveillance camera 302 provides video of secure children area 320 to monitors 304, 306 and 308. Monitors 304, 306 and 308 are provided in Internet access area 340, virtual home tour area 330 and browsing area 350, respectively. At least one Internet access unit 108 is located within Internet access area 340. Preferably, at least one virtual home tour unit 110 is located within virtual home tour area 330. Additionally, at least one real estate unit 102, mortgage unit 104 and insurance unit 106 are located within browsing area 350.

As previously discussed, a partition 344 can be provided to shield personal information of a potential buyer, utilizing mortgage unit 104, from prying eyes. In one embodiment, browsing area 350, Internet access area 340, virtual home tour area 330 and secure children area 320 are divided by partition walls. Partition walls provide privacy and security to a potential buyer. In a preferred embodiment, a parent or guardian can secure a child within secure children area 320 and, as previously stated, monitor the child using monitors 304, 306 and 308 that are located in the various areas. This allows a potential buyer to peruse available real estate information without concern for the well-being of their children. As will be apparent to one of ordinary skill in the art, any number of real estate units 102, mortgage units 104 and insurance units 106 can be provided (limited only by available floor space). Included at each real estate unit 102A, 102B and 102C is a smart phone 360, 362 and 364, respectively. Smart phones 368 and 366 are also preferably located at mortgage unit 104 and insurance unit 106. As previously discussed, smart phones 360-368 allow potential buyers access to another source of real estate service information.

The above description is considered that of the preferred embodiments only. Modification of the invention will occur to those skilled in the art and to those who make or use the invention. Therefore, it is understood that the embodiments shown in the drawings and described above are merely for illustrative purposes and not intended to limit the scope of the invention, which is defined by the following claims as interpreted according to the principles of patent law, including the Doctrine of Equivalents.

What is claimed is:

1. A method of providing automated real estate services, comprising the steps of:
providing a real estate kiosk that includes a real estate computer system coupled to a server, the real estate computer system automatically providing real property information to a potential buyer based on the potential buyer's indicated preference;
providing an insurance kiosk that includes an insurance computer system coupled to the server, the insurance computer system automatically providing insurance information to the potential buyer based on the potential buyer's indicated preference; and
providing a mortgage kiosk that includes a mortgage computer system coupled to the server, the mortgage computer system automatically providing mortgage information to the potential buyer based on the potential buyer's indicated preference.

2. The method of claim 1, wherein the real estate, insurance and mortgage kiosks are located at a retail shopping mall.

3. The method of claim 2, wherein the real estate kiosk is located in a common area of the retail shopping mall.

4. The method of claim 2, wherein the real estate, insurance and mortgage kiosks are located in a browsing area of a real estate store front.

5. The method of claim 4, further including the step of:
providing Internet access in an Internet access area that is separate from the browsing area.

6. The method of claim 5, further including the step of:
providing a virtual home tour in a virtual home tour area that is separate from the browsing and Internet access areas.

7. The method of claim 6, wherein the virtual home tour includes interactive views of at least one real property that is for sale.

8. The method of claim 7, wherein the virtual home tour includes interior, exterior and grounds views of at least one home that is for sale.

9. The method of claim 6, wherein the Internet access, browsing and virtual home tour areas are separated by partition walls.

10. The method of claim 1, wherein the real estate computer system audibly provides at least a portion of the real property information.

11. A real estate service system for providing real estate services, comprising:
a server for storing and providing access to real estate service information;
a real estate kiosk that includes a real estate computer system that is coupled to the server, the real estate computer system automatically providing real property information to a potential buyer based on the potential buyer's indicated preference;
an insurance kiosk that includes an insurance computer system that is coupled to the server, the insurance kiosk automatically providing insurance information to the potential buyer based on the potential buyer's indicated preference; and
a mortgage kiosk that includes a mortgage computer system that is coupled to the server, the mortgage kiosk automatically providing mortgage information to the potential buyer based on the potential buyer's indicated preference.

12. The system of claim 11, wherein the real estate, insurance and mortgage kiosks are located at a retail shopping mall.

13. The system of claim 12, wherein the real estate kiosk is located in a common area of the retail shopping mall.

14. The system of claim 12, wherein the real estate, insurance and mortgage kiosks are located in a browsing area of a real estate store front.

15. The system of claim 11, further including:
an Internet access computer system that is coupled to the server and provides Internet access, wherein the Internet access computer system is provided in an Internet access area that is separate from the browsing area.

16. The system of claim 15, further including:
a virtual home tour computer system that is coupled to the server and provides a virtual home tour, wherein the virtual home tour computer system is located in a virtual home tour area that is separate from the browsing and Internet access areas.

17. The system of claim 16, wherein the virtual home tour includes interactive views of at least one real property that is for sale.

18. The system of claim 17, wherein the virtual home tour includes interior, exterior and grounds views of at least one home that is for sale.

19. The system of claim 16, wherein the Internet access, browsing and virtual home tour areas are separated by partition walls.

20. The system of claim 11, wherein the real estate computer system audibly provides at least a portion of the real property information.

21. The system of claim 11, wherein the computer systems of the real estate, insurance and mortgage kiosks further include:
a processing unit;
a storage unit coupled to the processing unit, the storage unit storing real estate service information;
an output unit coupled to the processing unit, the output unit providing appropriate real estate service information to the potential buyer; and
an input unit coupled to the processing unit, the input unit receiving input from the potential buyer.

22. A real estate service system for providing real estate services in a retail shopping mall, comprising:
a server for storing and providing automated access to real estate service information;
a real estate kiosk located in a retail shopping mall and including a computer system that is coupled to the server, the real estate kiosk providing automated real estate service information to a potential buyer based on the potential buyer's indicated preference, the computer system further including:
a processing unit;
a storage unit coupled to the processing unit, the storage unit storing the real estate service information;
an output unit coupled to the processing unit, the output unit providing the real estate service information that corresponds to the potential buyers indicated preference; and
an input unit coupled to the processing unit, the input unit receiving the potential buyer's indicated preference.

23. The system of claim 22, further including:
a smart phone, the smart phone connecting the potential buyer to another source of real estate service information.

24. The system of claim 22, wherein the real estate service information includes real property, insurance and mortgage information.

25. The system of claim 22, further including a monitor coupled to the computer system, wherein the monitor is arranged to display real property information corresponding to the potential buyer's indicated preference such that an individual passing by can view the real property information.

26. The system of claim 22, wherein the real estate kiosk is located in a common area of the retail shopping mall.

27. The system of claim 22, wherein the real estate computer system audibly provides at least a portion of the real property information.

28. The system of claim 22, wherein the server is a remote server.

29. The system of claim 22, wherein the server is a local server.
